(19) United States
(12) Patent Application Publication
(10) Pub. No.: US 2007/0096688 A1
(43) Pub. Date: May 3, 2007

(54) Battery

(75) Inventors: Isao Suzuki, Kyoto-shi (JP); Takehito Matsubara, Kyoto-shi (JP); Noriyoshi Munenaga, Kyoto-shi (JP); Minoru Hirata, Kyoto-shi (JP); Seiji Nemoto, Kyoto-shi (JP); Takeshi Shimozono, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: GS YUASA CORPORATION, Kyoto (JP)

(21) Appl. No.: 10/578,408

(22) PCT Filed: Nov. 2, 2004
(86) PCT No.: PCT/JP04/16617

§ 371 Date: May 5, 2006

(30) Foreign Application Priority Data
Nov. 5, 2003 (JP) 2003-375121

(51) Int. Cl. H02J 7/00

(52) U.S. Cl. 320/112

(57) ABSTRACT

A battery in which a power generating element is accommodated in a battery case, wherein the battery case is composed of a flexible sheet, and at least part of the power generating element is covered with a cover member. This prevents the inner face of the flexible sheet from being damaged.

### TECHNICAL FIELD

The present invention relates to a battery which accommodates a power generating element in a battery case made of a flexible sheet such as an aluminum laminated sheet.

### BACKGROUND ART

Portable electronic equipment has employed a thin and light-weight battery which is achieved by employing an aluminum laminated sheet for the battery case to accommodate a power generating element. FIG. 3 shows a conventional battery which employs such a flexible battery case.

The battery, which is a nonaqueous electrolyte secondary battery having a high energy density, has a power generating element 1 and a battery case 2 accommodating the power generating element 1. The battery case 2 is composed of two rectangular aluminum laminated sheets 21 and 22. The power generating element 1 is obtained by winding a belt-like positive electrode having aluminum foil as its current collector, and a belt-like negative electrode having copper foil as its current collector, through a separator. The wound power generating element is further pressed from the sides into a flattened shape.

The belt-like positive and negative electrodes have a peripheral band, to which no active material is applied. This band is called the non-coated portion. When the belt-like positive and negative electrodes are wound as shown in FIG. 3, therefore, the aluminum foil protrudes from the top end face of the power generating element 1 as the non-coated portion of the positive electrode, and the copper foil protrudes from the bottom end face as the non-coated portion of the negative electrode. Lead terminals 3 and 4 are welded to the protruding portions of the aluminum foil and the copper foil.

The aluminum laminated sheets 21 and 22, which are flexible, are obtained by laminating the following three layers: a base film layer made of nylon resin or the like; a metal layer having barrier properties made of aluminum foil; and a sealant layer made of thermoplastic resin. The sealant layers of the two aluminum laminated sheets 21 and 22 are placed so as to face each other. The power generating element 1 is then held between the aluminum laminated sheets 21 and 22. The peripheries of the aluminum laminated sheets 21 and 22 are thermally welded to each other so that the battery is hermetically sealed.

The lead terminals 3 and 4, which are welded to the aluminum foil and the copper foil, protrude outward through the peripheries of the aluminum laminated sheets 21 and 22 overlapping each other. In this case, since a tab film is previously thermally welded to the lead terminals 3 and 4, the battery is hermetically sealed by welding the tab film to the aluminum laminated sheets 21 and 22.

Generally, the battery is hermetically sealed under reduced pressure in the battery. Accordingly, after the battery is hermetically sealed, the shape of the power generating element 1 affects the shapes of the aluminum laminated sheets 21 and 22.

### DISCLOSURE OF THE INVENTION

This conventional battery is disadvantageous as follows:

If the conventional nonaqueous electrolyte secondary battery is shaken or shocked by an external factor when used, the heavy power generating element 1 repeatedly collides against the inner faces of the aluminum laminated sheets 21 and 22 inside the battery case 2. At this time, since the non-coated portions made of aluminum foil and copper foil protrude from both ends of the power generating element 1, the non-coated portion can damage the sealant layer of the aluminum laminated sheet, or the like. Also, when the power generating element is formed by winding, the non-coated portion (shoulder 1a) of the power generating element becomes essentially solid. The solid non-coated portion can break through the aluminum laminated sheets 21 and 22 from inside, thereby destroying the battery case 2. Even if the aluminum laminated sheets 21 and 22 are not broken through, the non-coated portion of the power generating element 1 made of aluminum foil or copper foil can damage the inner sealant layer to come into contact with the barrier metal layer, thereby degrading the insulation.

Furthermore, like the conventional nonaqueous electrolyte secondary battery described above, in a battery employing the aluminum laminated sheets 21 and 22 for its outer packaging, if the pressure inside the battery is reduced to atmospheric pressure or below, the shape of the power generating element 1 inside the battery affects the shapes of the aluminum laminated sheets 21 and 22. The surface of the power generating element 1, however, has uneven spots, not being smooth entirely. The uneven spots appear also on the aluminum laminated sheets 21 and 22 as the battery outer packaging. Furthermore, wrinkles or folds appearing on the aluminum laminated sheets 21 and 22 detract from the battery appearance. Since such wrinkles or folds occur easily on the aluminum laminated sheet which covers the non-coated portion protruding from the power generating element 1, the appearance in the vicinity has particularly been an issue to be considered.

For a nonaqueous electrolyte secondary battery employing a battery case made of an aluminum laminated sheet, Japanese Published Patent Application No. 2000-357536A discloses an invention in which a reinforcing member is incorporated in a battery case. In that invention, the reinforcing member is incorporated in order to protect the power generating element if the battery case becomes deformed by gas emission due to overcharge or the like. A plate, frame, or the like inserted into the core of the power generating element as the reinforcing member is exemplified. Even in the case that the reinforcing member is placed outside the power generating element, the invention only shows an example in which two plates hold the power generating element. Therefore, even with any of the exemplified reinforcing members, it is impossible to prevent the metal foil of the power generating element from destroying the battery case.

It is an object of the present invention to prevent the power generating element from breaking through the battery case from the inside thereof due to shake, shock or the like, by way of covering the power generating element with a cover member. It is another object of the present invention to prevent wrinkles or folds from occurring on a flexible sheet.

The present invention relates to a battery which accommodates a power generating element in a battery case. The present invention is characterized in that the battery case is made of a flexible sheet and that the power generating element is at least partially covered with a cover member in the battery. This prevents the power generating element from coming into contact with or breaking through the inner face of the battery case directly, even when the battery is shaken or shocked. Therefore, a corner of the power generating element or the like does not damage the inner face of the flexible sheet, and the inner face of the flexible sheet is not broken through.

The portion covered with the cover member is preferably a non-coated portion of a positive or negative electrode composing the power generating element. Since no active material is applied to the non-coated portion, the non-coated portion exposes metal as its material. For this reason, the non-coated portion damages the inner face of the flexible sheet particularly easily than other members composing the power generating element.

However, covering only the non-coated portion with the cover member in the power generating element reduces battery manufacturing efficiency. This is because, in a battery manufacturing process, it is necessary to identify the position of the non-coated portion in order to cover the power generating element with the cover member. Therefore, a simpler method is preferred. Examples of such simple methods include a method in which the whole power generating element is covered with the cover member in a battery. The method does not have to identify the position of the non-coated portion in order to cover the power generating element with the cover member, thereby preventing reduction in battery manufacturing efficiency. Furthermore, since the cover member covers not only the non-coated portion which damages the flexible sheet particularly easily, but also the whole power generating element, the flexible sheet is protected completely. Therefore, the range of choices for the material of the flexible sheet is expanded. For example, a thin flexible sheet is applicable to the battery. Furthermore, its simple structure saves space, thereby improving the efficiency. To “cover the entire power generating element” here does not necessarily mean to cover the power generating element completely. Therefore, it would suffice if the power generating element is almost entirely covered. Specifically, it is possible, in FIG. 1 for example, that a hole made so that the lead protruding from the power generating element gets through the cover member can prevent the power generating element from being covered completely. Even such a case shall mean that the power generating element is completely covered provided that the power generating element is almost entirely covered.

As the cover member for covering the entire power generating element, a cup-shaped cover member is employed. In this case, the cup-shape means a shape in which a bottom plate has a sidewall plate. This shape further improves the manufacturing efficiency of the batteries. Specifically, the open sides of the two cup-shaped cover members face each other so that the power generating element is accommodated therebetween. Therefore, it becomes extremely simple to cover the power generating element with the cover members, thereby protecting the flexible sheet with ease. If the cup-shaped cover members cover the entire periphery of the power generating element, a hole for promoting the circulation of electrolyte solution may be created.

The peripheries of the two cup-shaped cover members joined to each other on the open sides may be fixed to each other in a simple manner with adhesive, adhesive tape or the like. It is also possible to fix the cup-shaped cover members to each other in a method such as thermal welding or the like. With no fear that the cover members might unusually go off from their normal positions in the battery case, the peripheries of the cover members do not necessarily have to be fixed to each other.

As such a cup-shaped cover member, for example, a long cylindrical, shallow container is employed so that both ends of the power generating element are fitted thereinto. If the power generating element is formed by laminating, since an edge of metal foil is exposed from all sides of the end face, a cup-shaped cover member which covers only the surroundings of the end face is employed. Whether the power generating element is formed by winding or laminating, the metal foil is seen from the end face of the power generating element as layers. Therefore, the cup-shaped cover member has to cover the end face as the non-coated portion so as to prevent the metal foil edge from coming into contact with or breaking into the flexible sheet directly. The cup-shaped cover member also has to cover the side face adjacent to the end face simultaneously so that the side face might not become misaligned from the end face or that the metal foil might not protrude out. Specifically, the cup-shaped cover member has to cover the periphery of the end face so that the end face is fitted thereinto.

The cup-shaped cover member preferably follows the shape of the part accommodating the power generating element, made of the flexible sheet. For a battery inside which the pressure is reduced down to atmospheric pressure or below, the flexible sheet as the battery case follows the shape of the power generating element. Since the surface of the power generating element has uneven spots, not being smooth entirely, the uneven spots appear also on the flexible sheet, thereby detracting from the battery appearance. Furthermore, the flexible sheet is disadvantageous in that wrinkles or folds occur easily thereon. However, if the cover member is provided between the battery case and the power generating element, the flexible sheet follows the shape of the cover member, thereby preventing wrinkles or folds from occurring thereon. Even when the pressure is equal to atmospheric pressure or below inside the battery, wrinkles or folds are difficult to occur, thereby manufacturing a battery without apparent flaws. Also, since the flexible sheet is difficult to damage due to wrinkles or folds, even when using the battery which has been manufactured, its appearance is still good. Furthermore, since wrinkles are difficult to occur, it is possible to employ a thin flexible sheet. Therefore, the range of choices for the material of the flexible sheet is expanded. The pressure reduction here means a pressure lower than one atmospheric pressure when atmospheric pressure is one atmosphere.

As the cover member, a resin molded part is employed, thereby offering the weight reduction to the battery, and further thereby insulating the power generating element from the battery case completely. The cover member preferably contains polyethylene, polyolefin such as polypropylene, polyethylene terephthalate or polyethylene sulfide, for example. The derivatives of these materials (rubbers included) may be employed. Unless easily destroyed by the non-coated portion made of metal foil, the cover member does not necessarily have to possess high rigidity. Therefore, a flexible resin sheet, glass fiber sheet, nonwoven fabric or the like may be employed. Any material may be employed for the cover member provided that the cover member resists electrolyte solution and is not damaged by the non-coated portion made of metal foil. It is possible, therefore, for the cover member to be made of metal. However, since a lightweight material having insulating properties is usually preferred, a material such as rubber or FRP (fiberglass reinforced plastics) is employed. Since the pressure is reduced inside the battery as has been mentioned above, the cover member is preferably rigid enough to maintain its structure even under a reduced pressure. A more specific description is as follows: For example, when the cover member is put in the case made of a flexible sheet and the pressure is reduced inside the case (for example, vacuum), atmospheric pressure is applied on the case, whereby the case applies a pressure corresponding to the difference between atmospheric pressure and the pressure inside the battery (one atmospheric pressure) to the cover member. The cover member is also preferably rigid enough not to become deformed against the pressure.

The cover member, which is not limited to have a specific thickness, is preferably 0.1 mm or thicker and 5 mm or thinner. With a thickness within the range, the member suffers a small deflection and frequently has the above-mentioned rigidity. Therefore, even when the pressure inside the battery is lower than atmospheric pressure, the cover member is ready to be supportive thereby preventing the flexible sheet from being pressed inside. As a result, no wrinkles or folds occur on the flexible sheet. On the other hand, when the cover member is thinner than 0.1 mm, wrinkles or folds easily occur on the flexible sheet. The cover member thicker than 5 mm is unfavorable in that the battery size becomes larger.

As the battery case, the two flexible sheets superimposed on each other are employed in general. However, the battery case may be formed by folding the single flexible sheet in half or superimposing the margins on each other at both ends and along a center line like an envelope. The battery case may also be obtained by forming the flexible sheet into a bag-shape previously. In the flexible sheet, a depression for accommodating the power generating element is provided. The power generating element is accommodated in the depression as a power generating element-accommodating part, and the flexible sheets are superimposed on each other thereon. The accommodating part may be provided in either of or both of the two flexible sheets. The same goes for the case when the single flexible sheet is folded in half. In other words, the accommodating part may be provided in either of or both of the faces of the flexible sheet. The superimposed margins of the flexible sheet may be bonded or the like instead of thermal welding. Furthermore, any material is applicable to the flexible sheet provided that the flexible sheet ensures adequate strength and barrier properties, and enables reliable hermetic sealing, not being limited to a laminated sheet.

The flexible sheet, which is not limited to have a specific thickness, is preferably 0.05 mm or thicker and 1 mm or thinner. With the flexible sheet within the range, the flexible sheet is difficult to press into the battery inside, thereby preventing wrinkles or folds on the flexible sheet. When the flexible sheet is thicker than 1 mm, almost no wrinkles or folds occur, with the disadvantage of making the battery heavier at the same time. When the flexible sheet is thinner than 0.05 mm, pinholes sometimes appear on the flexible sheet, which is inconvenient as the battery case.

The lead terminal generally protrudes outward from both end faces of the power generating element, but the present invention is not limited to the case. Both of the positive and negative lead terminals may protrude from either of the end faces or from a part other than the end faces (for example, the trailing end of the electrode winding).

The power generating element to be accommodated in the battery case may take any shape. Therefore, a power generating element wound into a long cylindrical or elliptic shape, a laminated power generating element or the like is applicable to the battery according to the present invention. And the effect of the present invention is got. However, when employing the power generating element formed by winding the electrode or the like, the effect according to the present invention becomes particularly advantageous. This is because the non-coated portion of the wound power generating element (shoulder 1a) becomes essentially solid thereby easily damaging the flexible sheet.

It should be noted that the battery employed for the present invention is not limited to any specific type. Specifically, the present invention is applicable to a secondary battery such as a nonaqueous electrolyte secondary battery, nickel-hydrogen battery or nickel-cadmium battery, and a primary battery.

### BRIEF DESCRIPTION OF DRAWINGS

FIG. 1 is an exploded perspective view illustrating the structure of a nonaqueous electrolyte secondary battery which employs a battery case made of an aluminum laminated sheet, showing one embodiment of the present invention;

FIG. 2 is a partially enlarged longitudinal cross-sectional view of the structure of an end of the nonaqueous electrolyte secondary battery which employs the battery case made of the aluminum laminated sheet, showing the one embodiment of the present invention; and

FIG. 3 is an exploded perspective view of the structure of a nonaqueous electrolyte secondary battery which employs a battery case made of an aluminum laminated sheet, showing a conventional example.

In each of the figures, reference numeral 1 denotes a power generating element; 2 a battery case; 21 and 22 aluminum laminated sheets; 3 a positive electrode lead terminal; 4 a negative electrode lead terminal; 5 an element cover; 51 and 52 cup-shaped covers; and 6 and 7 tab films.

### BEST MODE FOR CARRYING OUT THE INVENTION

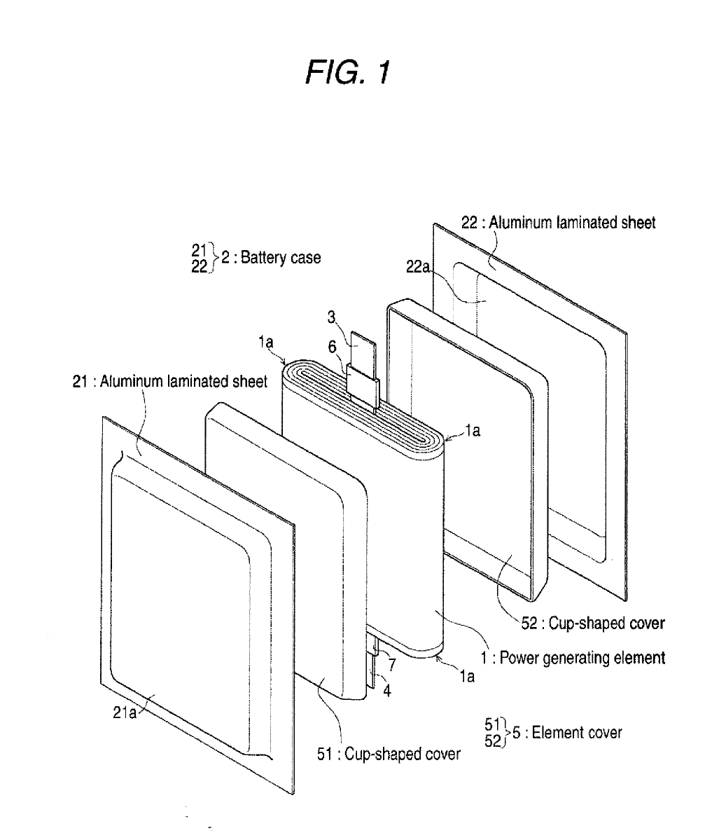

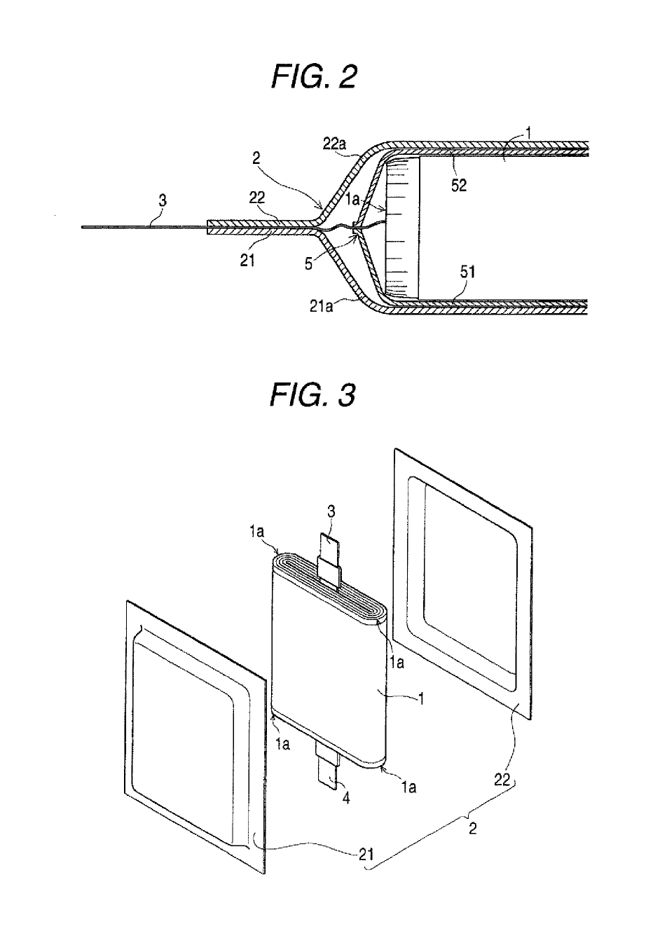

In the embodiment, referring to FIG. 1, a description is given for a nonaqueous electrolyte secondary battery in which the battery case 2 accommodating the power generating element 1 is made of the two aluminum laminated sheets 21 and 22, similarly to the conventional example. In FIG. 1 and FIG. 2, the structural members which have the same function as in the conventional example shown in FIG. 3 have the same reference number.

### EXAMPLE 1

(1. Preparation of the Power Generating Element)

A positive electrode was prepared by applying positive active material to the surface of a strip of aluminum foil. A negative electrode was prepared by applying negative active material to the surface of a strip of copper foil. The belt-like positive and negative electrodes had a band to which no active material was applied along the periphery of the aluminum foil and the copper foil (this is called “non-coated portion”). In order to structure the power generating element 1, when the positive and negative electrodes were wound, the non-coated portion on the aluminum foil as the positive electrode protruded from the end face upper in a winding axis direction, and the non-coated portion on the copper foil as the negative electrode protruded from the lower end face.

To the aluminum foil protruding from the upper end face of the power generating element 1, the lower end base of the positive electrode lead terminal 3 was ultrasonic-welded. To the copper foil protruding from the lower end face, the upper end base of the negative electrode lead terminal 4 was ultrasonic-welded. In this case, the positive electrode lead terminal 3 was made of a strip of aluminum foil while the negative electrode lead terminal 4 was made of a strip of copper foil.

The positive and negative electrodes were wound into a cylindrical shape through a separator, and then pressed from the sides into a flattened shape. This was employed as the power generating element 1. Accordingly, in the power generating element 1, the end of the positive electrode lead terminal 3 protruded upward from the upper end face of the power generating element while the end of the negative electrode lead terminal 4 protruded downward from the lower end face of the power generating element.

(2. Preparation of the Battery Case)

As the aluminum laminated sheets 21 and 22 employed for the battery case 2, a flexible sheet obtained by laminating a base film layer made of nylon resin or the like, a barrier layer made of aluminum foil and a sealant layer made of polypropylene or the like was employed. The two aluminum laminated sheets 21 and 22 were rectangular sheets of the same size. At the centers of the aluminum laminated sheets 21 and 22, power generating element-accommodating parts 21a and 22a were provided so as to accommodate the power generating element 1 between the aluminum laminated sheets superimposed on each other. The accommodating parts were formed by drawing.

(3. Accommodation of the Power Generating Element in the Cover Member)

The element cover 5 was obtained by superimposing the two cup-shaped covers 51 and 52 on each other from back and front. Each of the cup-shaped covers 51 and 52 was a resin part molded into a rectangular-cup-shaped, having a relatively small thickness, like a rectangular vat as cookware.

The cup-shaped covers 51 and 52 were superimposed on each other such that the respective depressions would face each other from back and front, thereby accommodating the power generating element 1 in the space created with the depressions. The depressions of the cup-shaped covers 51 and 52 were sized to cover the accommodated power generating element 1 leaving almost no clearance. The lead terminals 3 and 4 protruding upward/downward from both end faces of the power generating element 1 were held between the peripheral ends of the cup-shaped covers 51 and 52 so as to be pulled out. The cup-shaped covers 51 and 52 thus superimposed are simply fixed to each other by bonding the peripheral ends together, adhering adhesive tape near the periphery, or the like. In this Example, the cup-shaped covers were fixed to each other by bonding the peripheral ends together.

(4. Accommodation in the Battery Case)

As shown in FIG. 1, the two aluminum laminated sheets 21 and 22 were superimposed on each other at their peripheries from back and front so that the power generating element 1 covered with the element cover 5 would be accommodated in the space created with the power generating element accommodating parts 21a and 22a.

The lead terminals 3 and 4 protruding from the power generating element 1 between the cup-shaped covers 51 and 52 of the element cover 5 were held between the above and below peripheries of the aluminum laminated sheets 21 and 22 and then pulled out. The aluminum laminated sheets 21 and 22 thus superimposed were heated and pressure was applied thereon at their peripheries from back and front for thermal welding.

In practice, the aluminum laminated sheets 21 and 22 were thermal-welded not over the whole circumference of the peripheries at a time, but leaving an unwelded portion as an inlet. Subsequently, nonaqueous electrolyte solution was filled in through the inlet. After the nonaqueous electrolyte secondary battery was precharged, the inlet was hermetically sealed by thermal welding. For sealing hermetically, the pressure was reduced in the battery by a vacuum pump down to −0.95 atmospheric pressure based on gage pressure.

In the above and below peripheries of the battery, since the sealant layers of the two aluminum laminated sheets 21 and 22 were welded such that the lead terminals 3 and 4 were held therebetween, the battery was hermetically sealed in a state that the lead terminals 3 and 4 had been pulled out. To the lead terminals 3 and 4, tab films 6 and 7 were previously thermal-welded at a portion closer to the end rather than the base respectively. The tab films 6 and 7 were thin films made of thermoplastic resin such as polypropylene similarly to the sealant layer. The films were welded reliably to the lead terminals 3 and 4 by heating sufficiently in advance. When sealing hermetically by thermal welding, the aluminum laminated sheets 21 and 22 were welded to the tab films 6 and 7, and the tab films 6 and 7 were welded to the lead terminals 3 and 4, thereby ensuring hermeticity in the battery as shown in FIG. 2.

### EXAMPLE 2

During the course of the process of preparing the battery in Example 1, a battery was prepared in which the cover member described in the section (3. Accommodation of the power generating element in the cover member) covered the power generating element only partially. The battery was employed as the battery of Example 2.

### COMPARATIVE EXAMPLE 1

During the course of the process of preparing the battery in Example 1, a battery was prepared in which the step described in the section (3. Accommodation of the power generating element in the cover member) was omitted. Specifically, the battery does not have any cover member. The battery was employed as the battery of Comparative Example.

### COMPARISON AMONG EXAMPLES AND COMPARATIVE EXAMPLE

(Observations of Battery Appearances)

Regarding 100 batteries of Example 1, 100 batteries of Example 2, and 100 batteries of Comparative Example, their appearances were observed. A battery which has wrinkles in appearance is regarded low in commercial value. Therefore, such a battery was determined to be “nonconforming”. On the other hand, a battery with no wrinkles in appearance was determined to be “conforming”. Table 1 shows the determination result as to whether “conforming” or “nonconforming”.

TABLE 1

| | Ratio of “nonconforming” |
|---|---|
| | batteries to the batteries |
| | prepared |
| Batteries of | 0/100 |
| Example 1 | |
| Batteries of | 11/100 |
| Example 2 | |
| Batteries of | 100/100 |
| Comparative | |
| Example | |

As shown in Table 1, the batteries of Comparative Example had wrinkles on the aluminum laminated sheet thereby detracting from their appearances. The batteries of Example 2 had a number of wrinkles.

On the other hand, all the batteries of Example 1 had no wrinkles since the aluminum laminated sheet followed the element cover. Therefore, all the battery of Example 1 looked good.

(Vibration Test Result)

A vibration test adhering to IEC61960-1 was conducted on 100 batteries of Example 1, 100 batteries of Example 2 and 100 batteries of Comparative Example. After the vibration test, the batteries were disassembled. The aluminum-laminated inner face was visually observed. In the result, when damage was found on the aluminum-laminated inner face, the battery was determined to be “defective”. When no damage was found, the battery was determined to be “good”. Table 2 shows the test result.

TABLE 2

| | Ratio of “defective” batteries to |
|---|---|
| | the batteries tested |
| Batteries of | 0/100 |
| Example 1 | |
| Batteries of | 2/100 |
| Example 2 | |
| Batteries of | 92/100 |
| Comparative | |
| Example | |

As shown in Table 2, the batteries of Comparative Example became “defective” at a high ratio due to the vibration test. On the other hand, the number of the batteries of Example 1 and Example 2 which became “defective” was extremely small. Since the power generating element of the batteries was covered with the element cover, the non-coated portion of the power generating element was separated from the aluminum laminated sheet by the cover member, thereby preventing the non-coated portion of the power generating element from coming into contact with the inner face of the aluminum laminated sheet.

### INDUSTRIAL APPLICABILITY

The present invention relates to a battery which accommodates a power generating element in a battery case made of a flexible sheet such as an aluminum laminated sheet. At least part of the power generating element is covered with a cover member, thereby preventing the power generating element from coming into contact with or breaking into the inner face of the flexible sheet when the battery was shaken or the like. Therefore, the inner face of the flexible sheet is not damaged. Furthermore, if the power generating element is covered with the cover member, the flexible sheet follows the cover member, whereby the battery is not detracted in appearance. Any type of battery is applicable to the present invention provided that the battery employs a battery case made of a flexible sheet.

As has been described above, the present invention is industrially applicable to various types of batteries, and its industrial advantage is extremely large.

1. A battery in which a power generating element comprising a positive electrode, a negative electrode and a separator is accommodated in a battery case, wherein:
said battery case is composed of a flexible sheet, and
at least part of said power generating element is covered with a cover member in said battery case.

2. The battery according to claim 1, wherein:
said positive and negative electrodes comprise a non-coated portion, and
the part covered with said cover member is said non-coated portion.

3. A battery in which a power generating element comprising a positive electrode, a negative electrode and a separator is accommodated in a battery case, wherein:
said battery case is composed of a flexible sheet, and
said power generating element is entirely covered with a cover member in said battery case.

4. The battery according to any of claim 1 to 3,
wherein said cover member is cup-shaped.

5. The battery according to claim 4,
wherein said cup-shaped cover members cover said power generating element with open sides thereof facing each other.

6. The battery according to any of claim 1 to 3, wherein:
said battery is hermetically sealed, and
a pressure inside said battery is lower than atmospheric pressure.

7. The battery according to any of claim 1 to 3,
wherein said power generating element is formed by winding said positive and negative electrodes through said separator.

8. The battery according to claim 4, wherein:
said flexible sheet has an accommodating part for accommodating said power generating element, and
a shape of said accommodating part follows said cup-shaped cover member.

9. The battery according to any of claim 1 to 3,
wherein said cover member is 0.1 mm or thicker and 5 mm or thinner.

10. The battery according to any of claim 1 to 3,
wherein said cover member is a resin molded part.

11. The battery according to any of claim 1 to 3,
wherein said flexible sheet is 0.05 mm or thicker and 1 mm or thinner.
